(19) United States
(12) Patent Application Publication
(10) Pub. No.: US 2023/0274333 A1
(43) Pub. Date: Aug. 31, 2023

(54) SYSTEMS AND METHODS FOR INTEGRATING PHYSICAL AND VIRTUAL PURCHASING

(71) Applicant: Omni Consumer Products, LLC, Addison, TX (US)

(72) Inventor: Stephen Howard, Dallas, TX (US)

(73) Assignee: Omni Consumer Products, LLC, Addison, TX (US)

(21) Appl. No.: 18/004,520

(22) PCT Filed: Jul. 6, 2021
(86) PCT No.: PCT/US2021/040547

§ 371 Date: Jan. 6, 2023

Related U.S. Application Data
(60) Provisional application No. 63/049,112, filed on Jul. 7, 2020.

(51) Int. Cl. G06Q 30/0601

(52) U.S. Cl. CPC G06Q 30/0631; G06Q 30/0633; G06Q 30/0641

(57) ABSTRACT

A virtual kiosk system, comprises a memory, and a processor. The processor is configured to identify a user shopping in a retail store, and identify a product category that the user is shopping for in the retail store. The processor is configured to recommend products in the product category to the user. The processor is configured to receive user input from the user on the recommended products that are selected for purchase by the user, add the selected recommended products to a virtual shopping cart, and display the virtual shopping cart to the user so as to allow the user to purchase the selected recommended products.

### CROSS-REFERENCE TO RELATED APPLICATIONS

The disclosure claims priority to and benefit of U.S. Provisional Appl. No. 63/049,112, filed, Jul. 7, 2020, the entire disclosure of which is incorporated herein by reference.

### FIELD OF THE INVENTION

The disclosure relates to systems and methods for enabling users to virtually purchase products that are not physically displayed in a retail store, while the user is shopping for physical products in the store.

### BACKGROUND

Online shopping and virtual purchasing of products is becoming popular among consumers and allows user access to and purchase a wide variety of products. However, online purchasing is not a complete substitute for in person shopping in a retail store because consumers still like to physically see and touch products before making a purchase. While a variety of products in a product category may be displayed on a display area (e.g., a shelf or rack) of a retail store, limited display space prevents the retailer from displaying all of the products in a product category. For example, a retailer may have hundreds or thousands of products in a product category in its inventory or for sale on its website, but is only able to display a few on the display floor. If a consumer cannot find a desired product in a product category (e.g., a bicycle among many bicycles displayed in store, a food item, a board game, a toy, furniture, a home improve product, etc.) the consumer will either go to another retail store to look for the product, or search online for other options available to the consumer in the product category. Even if the user finds a product, the particular product may be damaged or is in a condition not suitable for purchase by the user. Such online searches are generally not limited to the retailer’s own website, and many customers end up shopping from other retailers if they did not find the product in store.

### SUMMARY

Embodiments described herein relate generally to systems and methods for enabling users to virtually purchase products not physically present in a retail store, while physically shopping for products in the store. Particularly, embodiments described herein relate generally to virtual kiosk systems that automatically identify and provide users recommendations on products available or not available in the retail store to the user so as to allow the user to add these products to a virtual shopping cart and purchase those products while shopping for physical products in the retail store.

In some embodiments, a virtual kiosk system comprises a memory, and a processor configured to identify a user shopping in a retail store. The processor is configured to identify a product category that the user is shopping for in the retail store. The processor is configured to recommend products in the product category to the user. The processor is configure to receive user input from the user on the recommended products that are selected for purchase by the user. The processor is configured to add the selected recommended products to a virtual shopping cart, and display the virtual shopping cart to the user so as to allow the user to purchase the selected recommended products.

In some embodiments, a portion of the selected recommended products are purchased at a physical retail location. In some embodiments, a portion of the selected recommended products are purchased at an e-commerce site. In some embodiments, the recommended products are not displayed in a display area of the retail store.

In some embodiments, the virtual kiosk system includes one or more image capture devices configured to capture an image of the user and the processor is configured to recognize the user based at least one image of the user captured by the one or more image capture devices. In some embodiments, the processor is configured to recognize the user via a signal received from a user device associated with the user.

In some embodiments, the processor is further configured to identify physical products selected by the user for purchase from the display area of the retail store. The processor is further configured to add the physical products to the virtual shopping cart so as to allow the user to purchase both the selected physical products and the selected recommended products via the virtual shopping cart.

In some embodiments, a method includes identifying, by a virtual kiosk system, a user shopping in a retail store, identifying, by the virtual kiosk system, a product category that the user is shopping for in the retail store, recommending, by the virtual kiosk system, products in the product category to the user, receiving, by the virtual kiosk system, user input from the user on the recommended products that are selected for purchase by the user, adding, by the virtual kiosk system, the selected recommended products to a virtual shopping cart, and displaying, by the virtual kiosk system, the virtual shopping cart to the user so as to allow the user to purchase the selected recommended products.

In some embodiments, a portion of the selected recommended products of the method are purchased at a physical retail location. In some embodiments, a portion of the selected recommended products of the method are purchased at an e-commerce site. In some embodiments, the recommended products of the method not displayed in a display area of the retail store. In some embodiments, the user is recognized, by the virtual kiosk system, via a signal received from a user device associated with the user.

In some embodiments, the method further includes identifying, by the virtual kiosk system, physical products selected by the user for purchase from the display area of the retail store and adding, by the virtual kiosk system, the physical products to the virtual shopping cart so as to allow the user to purchase both the selected physical products and the selected recommended products via the virtual shopping cart

In some embodiments, a non-transitory computer-readable media includes computer-readable instructions stored thereon that when executed by a processor causes the processor to identify a user shopping in a retail store, identify a product category that the user is shopping for in the retail store, recommend products in the product category to the user, receive user input from the user on the recommended products that are selected for purchase by the user, add the selected recommended products to a virtual shopping cart, and display the virtual shopping cart to the user so as to allow the user to purchase the selected recommended products.

In some embodiments, a portion of the selected recommended products are purchased at a physical retail location. In some embodiments, a portion of the selected recommended products are purchased at an e-commerce site. In some embodiments, the recommended products not displayed in a display area of the retail store. In some embodiments, the processor recognizes the user based on at least one image of the user captured by one or more image capture devices associated with a virtual kiosk system. In some embodiments, the processor recognizes the user via a signal received from a user device associated with the user.

In some embodiments, the processor identifies physical products selected by the user for purchase from the display area of the retail store and adds the physical products to the virtual shopping cart so as to allow the user to purchase both the selected physical products and the selected recommended products via the virtual shopping cart.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a block diagram illustrating virtual kiosk system for allowing a user to purchase products stored in database of a retail client system associated with a retail store but not physically displayed in a display area of the retail store, according to an embodiment.

FIG. 2 is a schematic block diagram of a user device, the virtual kiosk system, and the retail client system of FIG. 1, according to an embodiment.

FIG. 3 is a schematic flow chart of a method for allowing a user to virtually purchase a product while physically shopping for products in a retail store, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for enabling users to virtually purchase products not physically present in a retail store, while physically shopping for products in the store. Particularly, embodiments described herein relate generally to virtual kiosk systems that automatically identify and provide users recommendations on products available or not available in the retail store to the user so as to allow user to add these products to a virtual shopping cart and purchase those products while shopping for physical products in the retail store.

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations may be done in the same order of different order and that not all steps are required in every instance.

While a variety of products in a product category may be displayed on a display area (e.g., a shelf or rack) of a retail store, limited display space prevents the retailer from displaying all of the products in a product category. If a consumer cannot find a desired product in a product category (e.g., a bicycle among many bicycles displayed in store, a board game, a food item, furniture, a home improve product, etc.) the consumer will either go to another retail store to look for the product, or search online for other options available to the consumer in the product category. Such online searches are generally not limited to the retailer own website, and many customers end up shopping from other retailers if they did not find the product in store. This leads to loss of revenue and reduced customer loyalty.

In contrast, embodiments of the systems and methods described herein may provide one or more benefits including, for example: (1) automatically providing user suggestions on products in a product category that are not displayed in display area of the store without the user having to specifically go online to search for that product; (2) enabling users to virtually select and purchase selected items, thereby allowing swift and contactless purchase; (3) automatically recognizing and adding physical products selected for purchase by the user in a retail store to a virtual shopping cart to which the virtually selected products are added, thereby providing a seamless integrated physical and virtual purchase experience; and (4) reducing the probability of the user shopping on other online retail websites for the product in the product category not physically displayed in the display area of the retail store, thereby increasing customer loyalty, sales, and profits.

As described herein, the term “virtual purchase” refers to a purchase that is executed in a virtual environment such as an e-commerce site or an online purchasing application. Users are able to purchase both physical (i.e., tangible) and virtual (i.e., intangible) products within a virtual purchase.

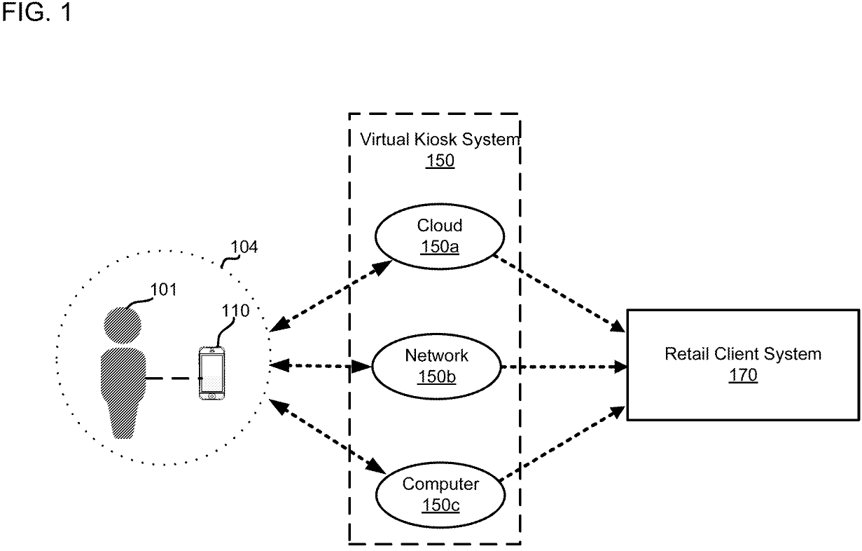

FIG. 1 is a block diagram illustrating virtual kiosk system 150 for allowing a user 101 to purchase products stored in database of a retail client system 170 associated with a retail store (e.g., WALMART®, TARGET®, COSTCO®, SAMS CLUB®, ALDI®, KROGER®, etc.), according to an embodiment. Such products may or may not be physically displayed in a display area of the retail store. Referring to FIG. 1, the user 101 may include at least one of a customer of the retail store. In some arrangements, the user 101 may be a regular customer of the retail store and information regarding the user 101 maybe stored in a user database of the virtual kiosk system 150. For example, the user 101 may have signed up for a user account with the retail client system 170, or is encouraged to sign up as the user 101 walks around the retail store. In other embodiments, the virtual kiosk system 150 may be configured to recognize the user 101 via any unique identifier, for example, gait, shoulder width, hair color, clothes, etc. In some arrangements, the user 101 operates or is otherwise associated with the user device 110. In particular arrangements, the virtual kiosk system 150 may be configured to communicate with the user 101 via the user device 110. The user device 110 may include, for example a mobile phone (e.g., an iPHONE®, an ANDROID® phone, a WINDOWS® phone, a SYMBIAN® phone or the likes), a tablet computer, a smart TV, a smart watch, or any other user device.

In some embodiments, the user 101 may operate the user device 110 to see recommendations provided by the virtual kiosk system 150 to the user device 110 regarding products in a product category that the user 101 is shopping for, and select one or more products among the recommended products for purchase. In some embodiments, the virtual kiosk system 150 may also build a virtual shopping cart on the user device 110 that includes the virtually selected products, and in some embodiments, also automatically add physical products picked by the user 101 from a display area of the retail store to the virtual shopping cart. This allows the user 101 to pay for both the physically and virtually selected items together via the virtual shopping cart. Mobile wallet or online payment features may be provided through software applications on the user device 110 to pay for the products in the virtual shopping cart.

The virtual kiosk system 150 may include one or more of a cloud 150a, a network 150b, or a computer 150c (e.g., a main frame, a personal computer, a laptop, a tablet, a mobile phone, etc.) and the like. The virtual kiosk system 150 is configured to identify a user 101 entering the retail store and provide recommendations to the user 101 for selecting products in a product category that the user 101 is interested in purchasing so as to allow the user 101 to virtually purchase products that are not displayed in a display area of the retail store.

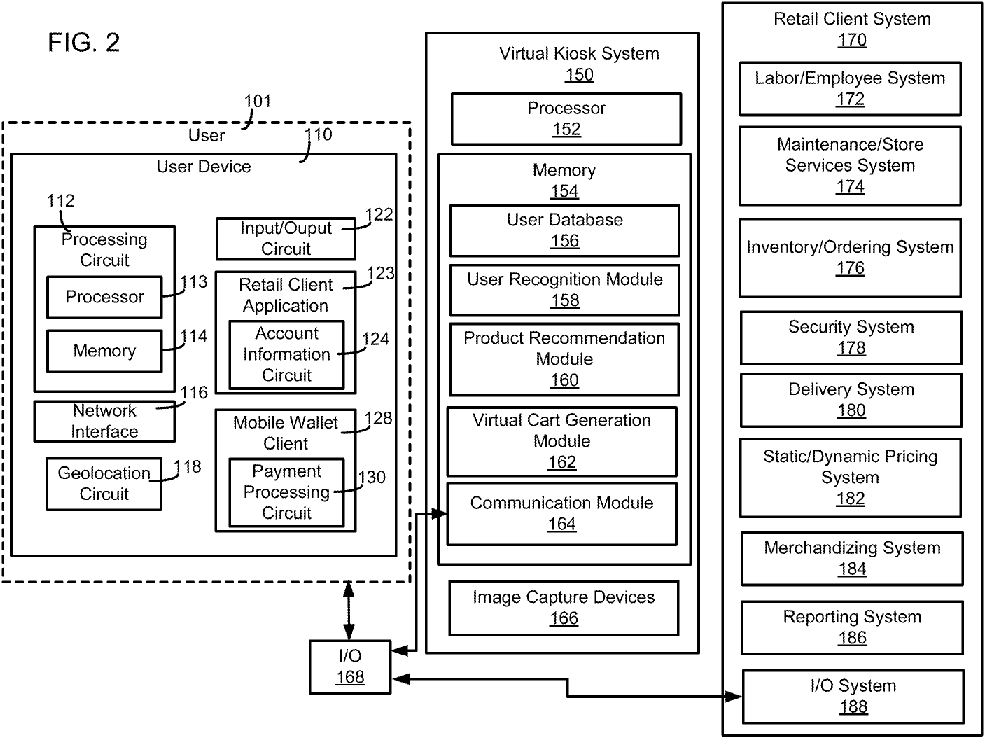

Expanding further, the virtual kiosk system 150 is configured to identify the user 101 shopping in the retail store. In some embodiments, the virtual kiosk system 150 may include one or more image capture devices, for example, the image capture devices 166 (e.g., CCD cameras, optical cameras that may include regular or fish eye lenses, etc.) shown in FIG. 2, configured to capture an image of the user 101 as the user enters the store. The virtual kiosk system 150 may include facial recognition technology or other feature recognition technology configured to identify the user 101, for example, based on information stored in a user database of the virtual kiosk system 150, or unique identifier of the user 101 as the user 101 enters the store. In such instances the user 101 may have previously signed up for a virtual kiosk program offered by the retail store and provided personal information including an image of the user 101 to the retail store that is then stored in the user database of the virtual kiosk system 150, or may consent to the program by simply walking into the store. The virtual kiosk system 150 recognizes the user 101 based on at least one image of the user 101 captured by the image capture devices.

In other embodiments, the virtual kiosk system 150 may be configured to recognize the user 101 via a signal received from the user device 110 associated with the user 101. For example, the virtual kiosk system 150 may recognize the user 101 based on a geolocation 104 of the user device 110, and thereby the user 101 when the user 101 enters the store (e.g., via GPS data received from the user device 110 using geofencing or any other geolocation application.)

The virtual kiosk system 150 is configured to identify a product category that the user 101 is shopping for in the retail store. For example, the virtual kiosk system 150 may track the movements of the user 101 through the store. As the user 101 stops at a display area (e.g., a shelf, a rack, a portion of the display floor, etc.) housing a particular product category (e.g., grocery, bicycles, sports goods, home goods, toiletries, medication, board games, toys, etc.), and starts interacting with the products, the virtual kiosk system 150 may determine that the user 101 is interested in purchasing the product.

The virtual kiosk system 150 is configured to recommend products in the product category to the user 101. The recommended products include products that not being displayed on a display area of the retail store. For example, due to limited space, a limited number of products in the product category are displayed to the user 101. However, the retail stores inventory may include many other products (e.g., hundreds or thousands of products) in the product category. Such products may be stored in a warehouse, onsite or off site of the retail store, or available via third parties.

In some embodiments, the virtual kiosk system 150 may include a display (e.g., a physical kiosk) positioned in front of the display area of the products that the user 101 is interacting with. The virtual kiosk system 150 generates a display signal configured to display recommended products in the product category that the user 101 is interested in purchasing on the display. This allows the user 101 to scroll through and visualize the complete inventory of the products in the product category available to the user 101 from the retail store. The recommended products may include the products currently on display in the store, or only those products that are not available in the store. In some embodiments, the virtual kiosk system 150 may also be configured to generate an audio signal configured to provide the user 101 more information about the product (e.g., via an AI audio assistant such as ALEXA®, SIRI®, GOOGLE®, or a similar voice assistant). In other embodiments, the virtual kiosk system 150 may display the recommended products to the user 101 on the user device 110. For example, the user 101 may be requested to activate an application associated with the retail store on the user device 110 on which the recommended products are shown, or the virtual kiosk system 150 may be configured to autonomously activate the app on the user device 110.

The virtual kiosk system 150 is configured to receive user input from the user 110 on the recommended products that are selected for purchase by the user 110. For example, the user 110 may select the products on the display associated with the virtual kiosk system 150, a vocal command, or on the user device 110. The virtual kiosk system 150 is configured to add the selected recommended products to a virtual shopping cart, and display the virtual shopping cart to the user 101 so as to allow the user to purchase the selected recommended products. The virtual kiosk system 150 may be configured to display the virtual shopping cart to the user on the display associated with the virtual kiosk system 150, or on the user device 110. In some embodiments, the user 101 may pay for the selected recommended products by checking out the virtual shopping cart, or paying at cashier counter of the retail store. In other embodiments, the virtual kiosk system 150 may be configured to automatically check out the user 101, as the user 101 exits the retail store, for example, if the user 101 is signed up for a contactless purchase program offered by the retail store.

In some embodiments, the virtual kiosk system 150 is configured to seamlessly integrate physical and virtual purchasing. The virtual kiosk system 150 identifies physical products selected by the user 101 for purchase from the display area of the retail store. For example, the virtual kiosk system 150 may be configured to recognize physical products being removed by the user 101 from the display area and being placed into a physical shopping cart associated with the user 101 or being carried away from the display shelf by the user 101 based on images of the user 101 and the products that are captured by the image capture devices. The virtual kiosk system 150 is configured to add the physical products to the virtual shopping cart so as to allow the user to purchase both the selected physical products and the selected recommended products via the virtual shopping cart. The user can then pay for all of the physically obtained products as well as the virtually selected products simultaneously by checking out the virtual shopping cart on the display associated with the virtual kiosk system 150, on the user device 110, or via contactless payment, as previously described.

FIG. 2 is a schematic block diagram of the user device 110 associated with the user 101, the virtual kiosk system 150, and the retail client system 170. As shown, the user 101 operates, or is associated with the user device 110. In some arrangements, the user device 110 includes a processing circuit 112 having a processor 113 and memory 114. The processor 113 is implemented as a general-purpose processor, an ASIC, one or more FPGAs, a DSP, a group of processing components that are distributed over various geographic locations or housed in a single location or device, or other suitable electronic processing components. The memory 114 may include a non-transitory, processor readable medium (e.g., RAM, NVRAM, ROM, Flash Memory, hard disk storage, etc.) stores data and/or computer code for facilitating the various processes described herein. Moreover, the memory 114 is or includes tangible, non-transient volatile memory or non-volatile memory. Accordingly, the memory 114 includes database components, object code components, script components, or any other type of information structure for supporting the various activities and information structures described herein.

The user device 110 is shown to include various circuits and logic for implementing the activities described herein. More particularly, the user device 110 includes one or more of a processing circuit 112, input/output (I/O) circuit 122, network interface 116, geolocation circuit 118, a retail client application 123 including account information circuit 124, payment processing circuit 216, a mobile wallet client application 128 including a payment processing circuit 130, or the like. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on the same processing circuit (e.g., the processing circuit 112), as additional circuits with additional functionality are included.

In some embodiments, the network interface 116 is configured for and structured to establish a communication session with the virtual kiosk system 150 and/or the retail client application 170, for example, when the user 101 enters the retail store. The I/O circuit 122 is configured to receive user input from, and provide information to the user 101. In this regard, the I/O circuit 122 is structured to exchange data, communications, instructions, etc., with an input/output component of the user device 110. Accordingly, in some arrangements, the I/O circuit 122 includes an input/output device such as a display device, touchscreen, keyboard, microphone, a finger print reader, and/or the like. In some arrangements, the I/O circuit 122 includes communication circuitry for facilitating the exchange of data, values, messages, and the like between the input/output device and the components of the user device 110. In some arrangements, the I/O circuit 122 includes machine-readable media for facilitating the exchange of information between the input/output device and the components of the user device 110. In still another arrangement, the I/O circuit 122 includes any combination of hardware components (e.g., a touchscreen), communication circuitry, mics, speakers, and machine-readable media.

In some embodiments, the mobile wallet client application 128 is a server-based application executable on the user device 110. In this regard, the user 101 has to first download the application(s) prior to usage. In another arrangement, mobile wallet client application 128 may be coded into the memory 114 of the user device 110. In still another arrangement, the mobile wallet client application 128 is a web-based interface applications. In this configuration, the user 101 has to log onto or otherwise access the web-based interface before usage. In this regard, the mobile wallet client application 128 is supported by a separate computing system comprising one or more servers, processors, network interface modules, etc. that transmit the applications for use to the user device 110. In certain arrangements, the mobile wallet client application 128 includes an Application Programming Interface (API) and/or a Software Development Kit (SDK) that facilitate integration of other applications. All such variations and combinations are intended to fall within the spirit and scope of the present disclosure.

In some embodiments, the virtual kiosk system 150 may be configured to receive payment from the user device 110 via the payment processing circuit 130 of the mobile wallet client application 128. For example, the payment processing circuit 130 may enable a quick-pay capability with the virtual kiosk system 150. In this regard, the payment processing circuit 130 includes or is communicably coupled with a communication device (e.g., a near-field communication chip) that facilitates the exchange of information between the mobile wallet client application 130 and a POS terminal. In other embodiments, the payment processing circuit 130 may be configured for contactless payment, for example, is activated when the user 101 leaves the store without the user 101 having to interact with a payment terminal.

The retail client application 123 is communicably coupled to the virtual kiosk system 150 (e.g., a user database 156 and/or a virtual shopping cart generation module 162) and/or the retail client system 150 (e.g., an inventory/ordering system 176). In some embodiments, the retail client applications 123 may be coupled to the virtual kiosk system 150 and/or the retail client system 170 via the network 150b is included in the virtual kiosk system 150 or to which the virtual kiosk system 150 is communicatively coupled to. The network 150b (e.g., a communication network) transmits the data package to the user device 110 and/or the retail client system 170. The network 150b may include any suitable Local Area Network (LAN) or Wide Area Network (WAN). For example, the network 110b can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The network 150b is structured to permit the exchange of data, values, instructions, messages, and the like between the virtual kiosk system 150 and the user device 110 and/or the retail client system 170.

In some arrangements, the retail client application 123 provides displays indicative of account information such as, but not limited to, a virtual shopping cart, product recommendations related to the product category the user 101 is shopping for, discounts, price comparisons, product reviews, previous orders, profile information (e.g., contact information), reward associated with the account, etc. As mentioned herein, the user 101 may pay for products physically obtained from the retail store or recommended products added to the virtual shopping cart via the retail client application 123. Accordingly and as shown, the banking client application 123 may include an account information circuit 123. The account information circuit 123 is linked or otherwise coupled to one or more profiles of the user associated with the user 101, that in some instances provide sufficient information to the virtual kiosk system 150 to recognize the user 101 when the user 110 enters the retail store. In other embodiments, the virtual kiosk system 150 may simply identify the user based on a unique visual identifier of the user 101, as previously described, regardless of whether the user 101′s information is present in a user database 156 of the virtual kiosk system 150.

In some arrangements, the user device 110 includes a geolocation circuit 118, which may include, for example a GPS or any other positioning system configured to determine a user device geolocation of the user device 110. Since the user device 110 is associated with the user 101, the user device geolocation may generally correspond to the user geolocation 104, as described herein. The geolocation circuit 118 may be operably coupled to one or more of the components of the user device 110, for example the retail client application 123 and/or the mobile wallet client application 128. In some embodiments, the geolocation circuit 118 communicates the user geolocation 104 to the virtual kiosk system 150 allowing the virtual kiosk system 150 to track the movements of the user 101 within the retail store.

The virtual kiosk system 150 includes a processor 152, a memory 154, a user database 156, a user recognition module 158, a product recommendation module 160, a virtual shopping cart generation module 162, a communication module 164, and a plurality of image capture devices 166.

The processor 152 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components.

The memory 154 stores data and/or computer code for facilitating at least some of the various processes described herein. The memory 154 includes tangible, non-transient volatile memory, or non-volatile memory. The memory 154 may include a non-transitory processor readable medium having stores programming logic that, when executed by the processor 152, controls the operations of the virtual kiosk system 150. Memory 154 may be any combination of one or more computer readable media. The computer readable media may be a computer readable signal medium, any type of memory or a computer readable non-transitory storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium may include, but are not limited to: a portable computer diskette, a hard disk, a random access memory (“RAM”), a read-only memory (“ROM”), a Non-volatile RAM (NVRAM), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device. In some arrangements, the processor 152 and the memory 154 form various processing circuits or modules described with respect to the virtual kiosk system 150 (e.g., the user recognition module 158, the product recommendation module 160, the virtual shopping cart generation module 162, the communication module 164, and/or the image capture devices 166).

Computer program code for carrying out operations utilizing a processor or CPU 162 for aspects of the present disclosure may be written in any combination of one or more programming languages, markup languages, style sheets and JavaScript libraries, including but not limited to Windows Presentation Foundation (WPF), HTML/CSS, Node, XAML, and JQuery, C, Basic, * Ada, Python, C++, C#, Pascal, * Arduino, JAVA and the likes. Additionally, operations can be carried out using any variety of compiler available.

The computer program instructions on memory 154 may be provided to the processor 152, where the processor 152 is of a general purpose computer, special purpose computer, microchip or any other programmable data processing apparatus to produce a machine, such that the instructions, which execute via the processor of the computer or other programmable instruction execution apparatus, create a mechanism for implementing the functions/acts specified in the flowchart and/or block diagram block or blocks. The computer instructions may do one or more of the following identify the user 101, identify the a product in a product category that the user 101 is shopping for, provide recommendations to the user 101 regarding other products in the product category (e.g., those not displayed in the respective display area of the retail store), add selected virtual and/or physical products to the virtual shopping cart, and/or allow the user 101 to pay for the virtual and/or physical products via the virtual shopping cart at a terminal or in a contactless fashion. The processor 152 is configured to control operations of the virtual kiosk system 150, for example, configured to execute instructions stored in the memory 154, or stored in the various modules.

These computer program instructions may also be stored in the memory 154 (computer readable medium) that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The user database 156 stores information pertaining to the user 101, for example, an identification image or other identification information, personal information, payment information, information on the user device 110, etc. The image capture device 166 may be one or more of the following a mono-camera, a stereo camera, a video camera, an infrared camera, a Realsense camera, Kinect Camera, Leap camera, a depth camera, a color camera, structured light camera, a combination thereof, and the likes. In one embodiment, multiple image capture devices 166 are used in a configuration where the image capture devices 166 may be angled in one or more angle to capture different views of the user 101 as the user 101 walks through the store, as well as capture images of the physical products being removed from the display area for purchase by the user 101. In another embodiment, the multiple image capture devices 166 may communicate with each other to learn location in relation to one another. For example, the image capture device 166 may communicate with another image capture device 166 on both sides off the shelf or isle in which the user 101 is standing or including roof mounted devices mounted on a roof of the retail store. Such communication is utilized for mapping of a facility or room mapping using depth, such as, a store, distribution center, etc., and determining the location of the user 101 in the facility (e.g., to track the user 101′s movement in the store).

As such, the virtual kiosk system 150 may be utilized for determining where objects, such as, goods, inventory, individuals, are located within the such a facility, capture images of the user 101 for user identification, and determine where the user 101 is located relative to a product on the retail store floor, as well as products that are being physically removed from the display area for purchase by the user 101. In some embodiments, the image capture devices 166 may be part of a drone monitoring system, for example, those described in U.S. Pat. App. No. 16/846,204, filed Apr. 10, 2020, the entire disclosure of which is hereby incorporated by reference herein. Various embodiments of monitoring drones and systems and methods of operating monitoring drones are also described in PCT Appl. No. PCT/US2018/045664, filed Aug. 7, 2018 and entitled “System, apparatus and method for a monitoring drone,” the entire disclosure of which is hereby incorporated by reference herein.

The user recognition module 158 is configure to identify the user 101, for example, by comparing images of the user 101 captured by the image capture devices 166 and comparing with those stored in the user database 156. In other embodiments, the user recognition module 158 may be configured to recognize the user 101 based on unique identifier of the user 101 that does not include facial recognition (e.g., user gait, hair color, shoulder width, clothes, etc.). In still other embodiments, the user recognition module 158 may be configured to recognize the user 101 based on a signal received from the user device 110.

The product recommendation module 160 is configured to identify a product category that the user 101 is shopping for in the retail store. For example, the product recommendation module 160 may receive an image of a product within a product category, which the user 101 removed from the display area, from the image capture devices 166, and identify the product category based on the removed product. The product recommendation module 160 displays recommended products in the product category to the user 101, which may solely or additionally include products not being displayed on a display area of the retail store.

For example, the product recommendation module 160 may obtain information on other products included in the product category from an inventory/ordering system 176 of the retail client system 170 via a communication module 164. The communication module 164 is structured for sending and receiving data from the retail client system 170, a I/O circuit 168 associated with the virtual kiosk system 150, the user device 110, computers, networks, cloud, and the likes. In some embodiments, the communication module 164 may include Ethernet, USB connection, port connections of various types, wireless, combination thereof and the likes. In some embodiments, the communication module 164 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like. The communication module 164 may communicate in real-time, in intervals, on demand, or a combination there of. The communication module 164 is configured to request information from the retail client system 170 regarding recommended products in the product category that are not displayed in the display area, generate signals to display the recommended products to the user 101, and/or receive information on selected recommended products that the user 101 has selected for purchase from the virtual recommended products.

In some embodiments, the virtual kiosk system 150 may display the recommended products to the user 101 on the I/O circuit 168. The I/O circuit 168 may also be configured to receive user input from and provide information to the user 101. In this regard, the I/O circuit 168 may be structured to exchange data, communications, instructions, etc. with an input/output component of the user device 110 and/or the retail client system 170. Accordingly, in some arrangements, the I/O circuit 168 includes an input/output device such as a display device, touchscreen, keyboard, microphone, speaker, and/or the like. In some arrangements, the I/O circuit 168 includes communication circuitry for facilitating the exchange of data, values, messages, and the like between the input/output device and the components of the virtual kiosk system 150. In still another arrangement, the I/O circuit 168 includes any combination of hardware components (e.g., a touchscreen), communication circuitry, and machine-readable media.

The virtual shopping cart generation module 162 is configured to receive user input from the user 101 on the recommended products that are selected for purchase by the user 101. The user 101 may make a user selection regarding the selected products on the I/O circuit 168 (e.g., a touch screen), via an audio command, or on the user device 110 (e.g., in the retail client application). The virtual shopping cart generation module 162 is configured to add the selected recommended products to a virtual shopping cart, and display the virtual shopping cart to the user 101 so as to allow the user 101 to purchase the selected recommended products. For example, the virtual shopping cart generation module 168 may display the virtual shopping cart to the user 101 on a display associated with the I/O circuit 168, or the user device 110, and the user 101 may execute the purchase after completing his shopping trip via the mobile wallet client application 128, online via the retail client application, via physical payment at a cashier location of the retail store, or contactless payment by automatic payment from the user 101 (e.g., the mobile wallet client application 128 of the user device 110) as the user 101 leaves the store.

In some embodiments, the virtual shopping cart generation module 162 is also configured to identify physical products selected by the user 101 for purchase from the display area of the retail store. For example, as the user 101 removes products from the display are, the image recognition devices 166 may capture images of the product being removed by the user 101 and the virtual shopping cart generation module 162 may recognize the product from the one or more images. The virtual shopping cart generation module 162 may be configured to add the physical products to the virtual shopping cart so as to allow the user to purchase both the selected physical products and the selected recommended products via the virtual shopping cart, as described above.

In some embodiments, the virtual kiosk system 150 is capable of performing analysis on an products and/or provide analytical data to one or more of systems of the retail client system 170 (e.g., a central inventory management system of the retail store) such as, for example, a labor/employee systems 172, a maintenance/store services system 174, an inventory/ordering system 176 (e.g., check inventory of products in product category, identify available products in product category for recommending to user 101), a security system 178, a delivery system 180 (e.g., order product from retail store warehouse based on virtual shopping cart), a static/dynamic pricing system 182 (in some cases for dynamic pricing), a merchandizing system 184, reporting/analytics system 186, and/or an I/O system 198, for example, a display or audio/visual devices included in the client system that may generate alarms/alerts.

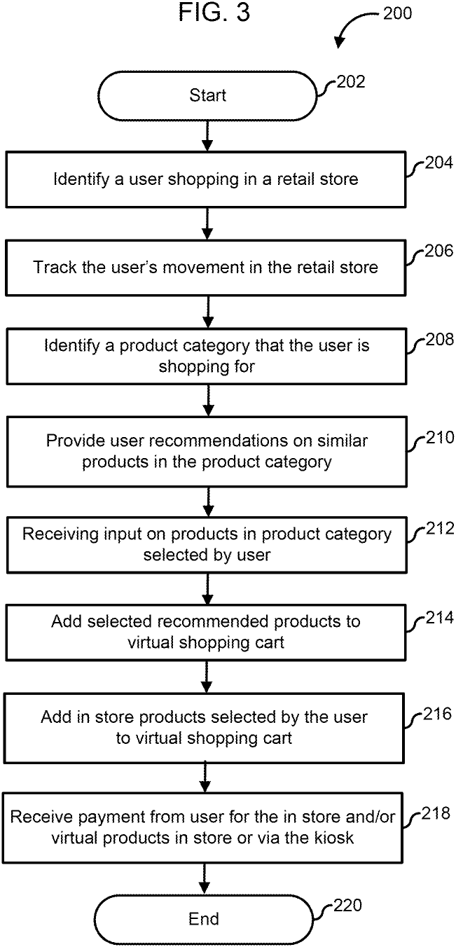

FIG. 3 is a schematic flow chart of a method 200 for allowing a user 101 to virtually purchase a product while physically shopping for products in a retail store, according to an embodiment. While the method 200 is described with respect to the virtual kiosk system 150, it should be appreciated that the operations of the method 200 may be implemented with any virtual kiosk system that communicates with any retail client system.

The method 200 starts at 202, and at 204, the processor 152 of the virtual kiosk system 150 identifies the user 101 shopping in the retail store. In some embodiments, the method 200 includes tracking, by the processor 152, the user’s movements in the retail store. For example, the processor 152 may be configured to identify the user 101′s movements based on images of the user 101 being captured by the image capture devices 166 or the geolocation 104 of the user 101 obtained from the user device 110.

At 208, the processor 152 identifies a product category that the user 101 is shopping for. For example, the processor 152 may be configured to interpret images of the product that the user 101 is interacting within a display area to determine the product category that the user 101 is shopping for. At 210, the processor 152 provides the user 101 recommendations on similar products in the product category such as those products that are not available in the store, for example, via the I/O circuit 168 and/or the user device 110. At 212, the processor 152 receives input form the user 101 (e.g., via the I/O circuit 168 and/or the user device 110) on products selected by the user 101 among the products recommended to the user 101.

At 214, the processor 152 adds the recommended products that are selected by the user 101 to a virtual shopping cart. In some embodiments, the method 200 also includes adding, by the processor 152, physical products selected and obtained for purchase in the retail store to the virtual shopping cart. At 218, the processor 150 is configured to receive payment for the virtually selected products and, in some embodiments, the physically purchased products via any of the methods described herein, and the method ends at 220.

In some embodiments, a virtual kiosk system comprises: a memory; and a processor configured to: identify a user shopping in a retail store, identify a product category that the user is shopping for in the retail store, recommend products in the product category to the user, receive user input from the user on the recommended products that are selected for purchase by the user, add the selected recommended products to a virtual shopping cart, and display the virtual shopping cart to the user so as to allow the user to purchase the selected recommended products.

In some embodiments, the recommended products are not displayed in a display area of the retail store. In some embodiments, the virtual kiosk system comprises one or more image capture devices configured to capture an image of the user, and the processor is configured to recognize the user based at least one image of the user captured by the images capture devices. In some embodiments, the processor is configured to recognize the user via a signal received from a user device associated with the user. In some embodiments, the processor is further configured to: identify physical products selected by the user for purchase from the display area of the retail store; and add the physical products to the virtual shopping cart so as to allow the user to purchase both the selected physical products and the selected recommended products via the virtual shopping cart.

It should be noted that the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples). The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “module” may include hardware structured to execute the functions described herein. In some arrangements, each respective “module” may include machine-readable media for configuring the hardware to execute the functions described herein. The module may be embodied as one or more circuitry components including, but not limited to, processing circuitry, network interfaces, peripheral devices, input devices, output devices, sensors, etc. In some arrangements, a module may take the form of one or more analog circuits, electronic circuits (e.g., integrated circuits (IC), discrete circuits, system on a chip (SOCs) circuits, etc.), telecommunication circuits, hybrid circuits, and any other type of “module.” In this regard, the “module” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “module” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “module” as described herein may include components that are distributed across one or more locations.

An exemplary system for implementing the overall system or portions of the arrangements and embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick, touch sensitive screen or other input devices performing a similar function. Comparatively, the term “output device,” as described herein, may include any type of output device including, but not limited to, a computer monitor, printer, facsimile machine, a LAN card or WiFi® transmission circuit for data transmission or other output devices performing a similar function

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and

While this specification contains many specific implementation details, these should not be construed as limitations on the scope of any arrangement or of what may be claimed, but rather as descriptions of features specific to particular implementations of particular arrangements. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A virtual kiosk system, comprising:
a memory; and
a processor configured to:
identify a user shopping in a retail store,
identify a product category that the user is shopping for in the retail store,
recommend products in the product category to the user,
receive user input from the user on the recommended products that are selected for purchase by the user,
add the selected recommended products to a virtual shopping cart, and
display the virtual shopping cart to the user so as to allow the user to purchase the selected recommended products.

2. The virtual kiosk system of claim 1, wherein a portion of the selected recommended products are purchased at a physical retail location.

3. The virtual kiosk system of claim 1, wherein a portion of the selected recommended products are purchased at an e-commerce site.

4. The virtual kiosk system of claim 1, wherein the recommended products are not displayed in a display area of the retail store.

5. The virtual kiosk system of claim 1, wherein:
the virtual kiosk system comprises one or more image capture devices configured to capture an image of the user; and
the processor is configured to recognize the user based at least on one image of the user captured by the one or more image capture devices.

6. The virtual kiosk system of claim 1, wherein the processor is configured to recognize the user via a signal received from a user device associated with the user.

7. The virtual kiosk system of claim 6, wherein the processor is further configured to:
identify physical products selected by the user for purchase from the display area of the retail store; and
add the physical products to the virtual shopping cart so as to allow the user to purchase both the selected physical products and the selected recommended products via the virtual shopping cart.

8. A method, comprising:
identifying, by a virtual kiosk system, a user shopping in a retail store;
identifying, by the virtual kiosk system, a product category that the user is shopping for in the retail store;
recommending, by the virtual kiosk system, products in the product category to the user;
receiving, by the virtual kiosk system, user input from the user on the recommended products that are selected for purchase by the user;
adding, by the virtual kiosk system, the selected recommended products to a virtual shopping cart; and
displaying, by the virtual kiosk system, the virtual shopping cart to the user so as to allow the user to purchase the selected recommended products.

9. The method of claim 8, wherein a portion of the selected recommended products are purchased at a physical retail location.

10. The method of claim 8, wherein a portion of the selected recommended products are purchased at an e-commerce site.

11. The method of claim 8, wherein the recommended products not displayed in a display area of the retail store.

12. The method of claim 8, wherein the user is recognized, by the virtual kiosk system, via a signal received from a user device associated with the user.

13. The method of claim 11, wherein the method further comprises:
identifying, by the virtual kiosk system, physical products selected by the user for purchase from the display area of the retail store; and
adding, by the virtual kiosk system, the physical products to the virtual shopping cart so as to allow the user to purchase both the selected physical products and the selected recommended products via the virtual shopping cart.

14. A non-transitory computer-readable media comprising computer-readable instructions stored thereon that when executed by a processor causes the processor to:
identify a user shopping in a retail store,
identify a product category that the user is shopping for in the retail store,
recommend products in the product category to the user,
receive user input from the user on the recommended products that are selected for purchase by the user,
add the selected recommended products to a virtual shopping cart, and
display the virtual shopping cart to the user so as to allow the user to purchase the selected recommended products.

15. The non-transitory computer-readable media of claim 14, wherein a portion of the selected recommended products are purchased at a physical retail location.

16. The non-transitory computer-readable media of claim 14, wherein a portion of the selected recommended products are purchased at an e-commerce site.

17. The non-transitory computer-readable media of claim 14, wherein the recommended products not displayed in a display area of the retail store.

18. The non-transitory computer-readable media of claim 14, wherein the computer readable instructions are further configured to cause the processor to recognize the user based on at least one image of the user captured by one or more image capture devices associated with a virtual kiosk system.

19. The non-transitory computer-readable media of claim 14, wherein the computer readable instructions are further configured to cause the processor to recognize the user via a signal received from a user device associated with the user.

20. The non-transitory computer-readable media of claim 17, wherein the computer readable instructions are further configured to cause the processor to:
identify physical products selected by the user for purchase from the display area of the retail store; and
add the physical products to the virtual shopping cart so as to allow the user to purchase both the selected physical products and the selected recommended products via the virtual shopping cart.
